(19) United States
(12) Patent Application Publication
(10) Pub. No.: US 2016/0091965 A1
(43) Pub. Date: Mar. 31, 2016

(54) NATURAL MOTION-BASED CONTROL VIA WEARABLE AND MOBILE DEVICES

(71) Applicant: Microsoft Corporation, Redmond, WA (US)

(72) Inventors: Jiaping Wang, Bellevue, WA (US); Yujia Li, Toronto (CA); Xuedong Huang, Bellevue, WA (US); Lingfeng Wu, Bellevue, WA (US); Wei Xiong, Bellevue, WA (US); Kaisheng Yao, Newcastle, WA (US); Geoffrey Zweig, Sammamish, WA (US)

(21) Appl. No.: 14/502,549

(22) Filed: Sep. 30, 2014

(51) Int. Cl. G06F 3/01; G06F 1/16

(52) U.S. Cl. CPC G06F 3/011; G06F 3/017; G06F 1/163

(57) ABSTRACT

A “Natural Motion Controller” identifies various motions of one or more parts of a user's body to interact with electronic devices, thereby enabling various natural user interface (NUI) scenarios. The Natural Motion Controller constructs composite motion recognition windows by concatenating an adjustable number of sequential periods of inertial sensor data received from a plurality of separate sets of inertial sensors. Each of these separate sets of inertial sensors are coupled to, or otherwise provide sensor data relating to, a separate user worn, carried, or held mobile computing device. Each composite motion recognition window is then passed to a motion recognition model trained by one or more machine-based deep learning processes. This motion recognition model is then applied to the composite motion recognition windows to identify a sequence of one or more predefined motions. Identified motions are then used as the basis for triggering execution of one or more application commands.

### BACKGROUND

Smartwatches and other wearable or mobile computing devices provide various levels of computational functionality. Such functionality enables tasks such as voice or data communications, data storage and transfer, calculations, media recording or playback, games, fitness tracking, etc. From a hardware perspective, many smartwatches and other wearable or mobile devices include a wide range of sensors such as cameras, microphones, speakers, accelerometers, display devices, touch sensitive surfaces, etc. Smartwatches and other wearable or mobile devices typically run various operating systems and often run any of a variety of applications. Many of these devices also offer wireless connectivity or interactivity with other computational devices using technologies such as Wi-Fi, Bluetooth, near-field communication (NFC), etc.

### SUMMARY

The following Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Further, while certain disadvantages of other technologies may be noted or discussed herein, the claimed subject matter is not intended to be limited to implementations that may solve or address any or all of the disadvantages of those other technologies. The sole purpose of this Summary is to present some concepts of the claimed subject matter in a simplified form as a prelude to the more detailed description that is presented below.

In general, a “Natural Motion Controller,” as described herein, provides various techniques for identifying motions of one or more parts of a user's body to interact with electronic devices, thereby enabling various natural user interface (NUI) scenarios. Advantageously, the Natural Motion Controller provides increased user productivity and interactivity with respect to a wide range of computing devices and electronically controlled or actuated devices or machines, by triggering execution of a sequence of one or more application commands in response to an identified sequence of one or more predefined motions of one or more parts of the user's body. These motions are identified based on inertial sensor data, optionally combined with other sensor data (e.g., optical, temperature, proximity, etc.), returned by sensor sets coupled to, or otherwise associated with, one or more user worn, carried, or held mobile computing devices.

In various implementations, some of the processes enabled by the Natural Motion Controller begin by periodically or continuously constructing composite motion recognition windows from the sensor data. These motion recognition windows may be constructed by concatenating an adjustable number of sequential periods or frames of inertial sensor data received from a plurality of separate sets of inertial sensors. Each of these separate sets of inertial sensors are coupled to, or otherwise provide sensor data relating to, a separate user worn, carried, or held mobile computing device. Each composite motion recognition window is then passed to a machine-learned motion sequence model, also referred to herein as a “motion recognition model,” trained by one or more machine-based deep learning processes. This motion recognition model is then applied to the composite motion recognition windows to identify a sequence of one or more predefined motions of one or more parts of the user's body.

Once these predefined motions have been identified, the Natural Motion Controller triggers execution of a sequence of one or more application commands in response to the identified sequence of one or more predefined motions. For example, in various implementations, a user wrist or arm twist is detected as a motion that triggers the activation of a microphone of a communications component of a user worn smartwatch or the like. However, it should be understood that the Natural Motion Controller is not limited to twist-based motions, or to activation of microphones or other communications devices.

In view of the above summary, it is clear that the Natural Motion Controller described herein provides various techniques for identifying motions of one or more parts of a user's body to interact with computing devices and electronically controlled or actuated devices or machines, thereby enabling various NUI scenarios. In addition to the just described benefits, other advantages of the Natural Motion Controller will become apparent from the detailed description that follows hereinafter when taken in conjunction with the accompanying drawing figures.

### BRIEF DESCRIPTION OF THE DRAWINGS

The specific features, aspects, and advantages of the claimed subject matter will become better understood with regard to the following description, appended claims, and accompanying drawings where:

FIG. 1 provides an exemplary architectural flow diagram that illustrates program modules for effecting various implementations of the Natural Motion Controller, as described herein.

FIG. 2 provides an exemplary high-level overview for training machine-learned motion sequence models, as described herein

FIG. 3 illustrates a user-worn control device in a smartwatch form factor worn on a user's wrist, as described herein.

FIG. 4 illustrates a general system flow diagram that illustrates exemplary methods for effecting various implementations of the Natural Motion Controller, as described herein.

FIG. 5 is a general system diagram depicting a simplified general-purpose computing device having simplified computing and I/O capabilities for use in effecting various implementations of the Natural Motion Controller, as described herein.

### DETAILED DESCRIPTION

In the following description of various implementations of a “Natural Motion Controller,” reference is made to the accompanying drawings, which form a part hereof, and in which is shown by way of illustration specific implementations in which the Natural Motion Controller may be practiced. It should be understood that other implementations may be utilized and structural changes may be made without departing from the scope thereof.

It is also noted that, for the sake of clarity, specific terminology will be resorted to in describing the various implementations described herein, and that it is not intended for these implementations to be limited to the specific terms so chosen. Furthermore, it is to be understood that each specific term includes all its technical equivalents that operate in a broadly similar manner to achieve a similar purpose. Reference herein to “one implementation,” or “another implementation,” or an “exemplary implementation,” or an “alternate implementation” or similar phrases, means that a particular feature, a particular structure, or particular characteristics described in connection with the implementation can be included in at least one implementation of the Natural Motion Controller. Further, the appearance of such phrases throughout the specification are not necessarily all referring to the same implementation, nor are separate or alternative implementations mutually exclusive of other implementations.

It should also be understood that the order described or illustrated herein for any process flows representing one or more implementations of the Natural Motion Controller does not inherently indicate any requirement for the processes to be implemented in the order described or illustrated, nor does any such order described or illustrated herein for any process flows imply any limitations of the Natural Motion Controller.

As utilized herein, the terms “component,” “system,” “client” and the like are intended to refer to a computer-related entity, either hardware, software (e.g., in execution), firmware, or a combination thereof. For example, a component can be a process running on a processor, an object, an executable, a program, a function, a library, a subroutine, a computer, or a combination of software modules and hardware. By way of illustration, both an application running on a server and the server can be a component. One or more components can reside within a process and a component can be localized on one computer and/or distributed between two or more computers. The term “processor” is generally understood to refer to a hardware component, such as a processing unit of a computer system.

Furthermore, the terms “includes,” “including,” “has,” “contains,” variants thereof, and other similar words and phrases that may be used in either this detailed description or the claims are intended to be inclusive in a manner similar to the term “comprising” as an open transition word without precluding any additional or other elements.

### 1.0 Introduction

In general, a “Natural Motion Controller,” as described herein, provides various techniques for identifying motions of one or more parts of a user's body to interact with and control computing devices and electronically controlled or actuated devices or machines, thereby enabling various natural user interface (NUI) scenarios. Motions of user body parts are identified by a machine-learned motion sequence model from inertial sensor data, optionally combined with other sensor data (e.g., optical, temperature, proximity, etc.), returned by sensor sets coupled to, or otherwise associated with, one or more user worn, carried, or held mobile computing devices. Note that for purposes of discussion, these user worn, carried, or held mobile computing devices are sometimes referred to herein as “user worn control devices,” regardless of the particular form factor of those devices.

The interaction and control enabled by the Natural Motion Controller is achieved by triggering execution of a sequence of one or more application commands in response to an identified sequence of one or more predefined motions of one or more parts of the user's body. These capabilities provide various advantages and technical effects in view of the following detailed description. Examples of these advantages and technical effects include, but are not limited to, improved user efficiency by providing devices and processes that enable users to perform simple body motions to control one or more computing devices and electronically controlled or actuated devices or machines. Such capabilities further serve to increase user interaction performance by allowing users to automatically and/or remotely control or interact with a plurality of computing devices and electronically controlled or actuated devices or machines by performing simple body part motions without the need to physically interact with those devices.

In various implementations, the computing devices and electronically controlled or actuated devices or machines controlled via triggering application commands include the user worn control devices that are used to provide sensor data corresponding to user motions. For example, a smartwatch form factor with inertial sensors may also include a variety of communications capabilities that are triggered or otherwise controlled in response to user body part motions such as, for example, a twist of the user's wrist.

However, it should also be understood that triggering of application commands can be used to control or interact with any local or remote computing device or electronically controlled or actuated device or machine capable of receiving or responding to application commands via any desired wired or wireless communications link. For example, triggered application commands may be used to control or interact with devices including, but not limited to, smart home type appliances and switches, cameras, televisions, computing devices, communications equipment, etc. For example, inertial sensor data received from a user worn control device, such as, for example, a wristband or ring-based form factor, may indicate motions such as, for example, a user waving her hand or snapping her fingers. Such motions can be used to initiate or trigger any predefined or user-defined application command for any local or remote computing device or electronically controlled or actuated device or machine capable of receiving or responding to application commands.

1.1 System Overview:

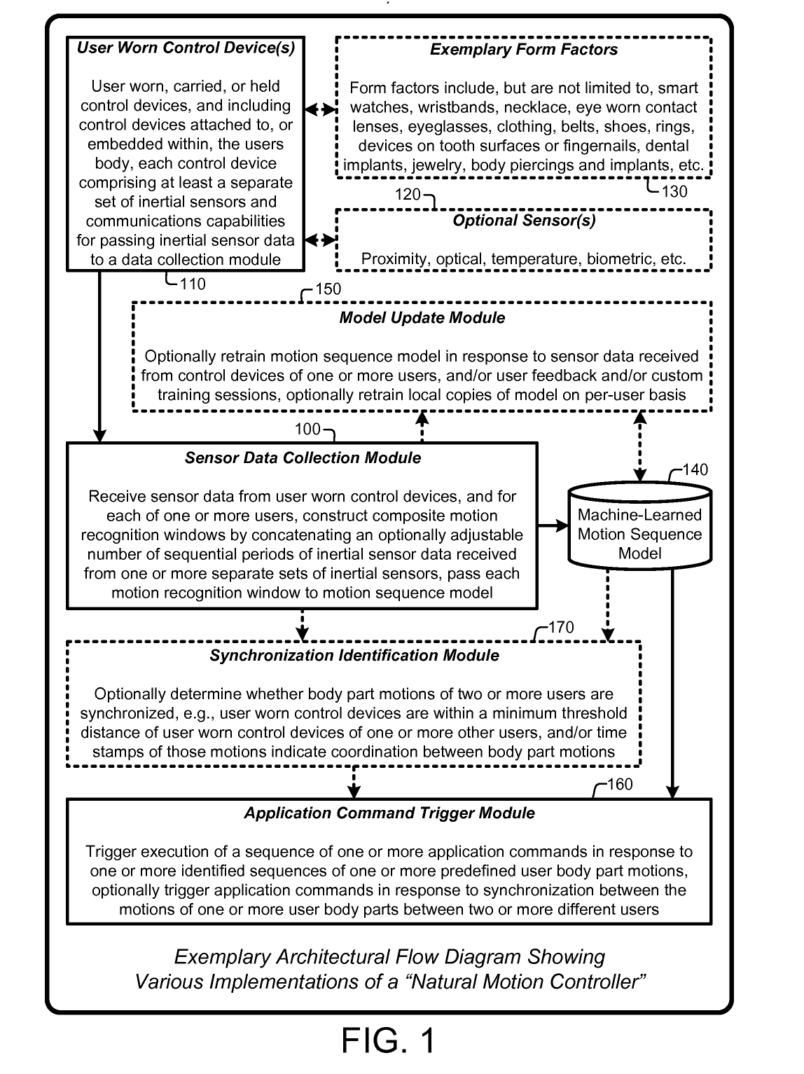

As noted above, the “Natural Motion Controller,” provides various techniques for identifying motions of one or more parts of a user's body to interact with computing devices and electronically controlled or actuated devices or machines, thereby enabling various NUI scenarios. The processes summarized above are illustrated by the general system diagram of FIG. 1. In particular, the system diagram of FIG. 1 illustrates the interrelationships between program modules for implementing various implementations of the Natural Motion Controller, as described herein. Furthermore, while the system diagram of FIG. 1 illustrates a high-level view of various implementations of the Natural Motion Controller, FIG. 1 is not intended to provide an exhaustive or complete illustration of every possible implementation of the Natural Motion Controller as described throughout this document.

In addition, it should be noted that any boxes and interconnections between boxes that may be represented by broken or dashed lines in FIG. 1 represent alternate implementations of the Natural Motion Controller described herein, and that any or all of these alternate implementations, as described below, may be used in combination with other alternate implementations that are described throughout this document.

In general, as illustrated by FIG. 1, the processes enabled by the Natural Motion Controller begin operation by applying a sensor data collection module 100 to receive sensor data from one or more user worn control devices 110. Examples of these user worn control devices 110 include user worn, carried, or held control devices, and optionally include one or more control devices attached to, or embedded within, the users body. Each of these user worn control devices 110 comprise at least a separate set of inertial sensors and communications capabilities for passing inertial sensor data to the sensor data collection module 100.

In various implementations, one or more of the user worn control devices 110 may include one or more additional optional sensors 120. Examples of these optional sensors 120 include, but are not limited to, proximity sensors, optical sensors, temperature sensors, biometric sensors, etc. Exemplary form factors 130 for the user worn control devices 110 include, but are not limited to, smartwatches, wristbands, necklaces, eye worn contact lenses, eyeglasses, clothing, belts, shoes, rings, devices on tooth surfaces or fingernails, dental implants, jewelry, body piercings and implants, etc.

For each of one or more users, the sensor data collection module 100 constructs composite motion recognition windows by concatenating an optionally adjustable number of sequential periods or frames of inertial sensor data received from one or more separate sets of inertial sensors. The sensor data collection module 100 then passes these motion recognition windows to a machine-learned motion sequence model 140 that has been trained by applying one or more deep-learning processes to positive and negative examples of inertial sensor data corresponding to one or more predefined user body part motions. The machine-learned motion sequence model 140 then identifies a sequence of one or more corresponding user body part motions from the composite motion recognition windows received from the sensor data collection module 100.

In various implementations, an optional model update module 150 optionally retrains the machine-learned motion sequence model 140 in response to sensor data received from the control devices 110 of one or more users, and/or user feedback and/or custom training sessions. In further optional implementations, the model update module 150 optionally retrains local copies of the machine-learned motion sequence model 140 on per-user basis such that the machine-learned motion sequence model associated with individual users increasingly adapts to particular motions of those users over time.

An application command trigger module 160 triggers execution of a sequence of one or more application commands in response to one or more identified sequences of one or more predefined user body part motions returned by the machine-learned motion sequence model 140. These application commands enable the user to interact with computing devices and electronically controlled or actuated devices or machines via the user body part motions identified by the machine-learned motion sequence model 140.

Note that in various implementations, the computing devices and electronically controlled or actuated devices or machines controlled via triggering of the one or more application commands include the user worn control devices 110. For example, a smartwatch form factor may include a variety of communications capabilities that are triggered or otherwise controlled in response to user body part motions identified by the machine-learned motion sequence model 140. However, it should also be understood that the application command trigger module 160 can be used to control or interact with any local or remote computing device or electronically controlled or actuated device or machine capable of receiving or responding to application commands.

Further, in various implementations, application command trigger module 160 optionally triggers application commands in response to synchronization between the motions of one or more user body parts between two or more different users. Such synchronization is determined by an optional synchronization identification module 170 that operates to optionally determine whether body part motions of two or more users (identified by the machine-learned motion sequence model 140) are synchronized.

In various implementations, the synchronization identification module 170 identifies synchronized motions when user worn control devices 110 of one user are within a minimum threshold distance of user worn control devices of one or more other users (determined via the use of optional proximity sensors). In further implementations, the synchronization identification module 170 identifies synchronized motions when time stamps associated with those motions indicate coordination between body part motions of different users (e.g., two users shaking each other's hands). Note also that in various implementations, both time stamps and threshold distances may be combined when determining whether body part motions of two or more users are synchronized.

### 2.0 Operational Details of the Natural Motion Controller

The above-described program modules are employed for implementing various implementations of the Natural Motion Controller. The following sections provide a detailed discussion of the operation of various implementations of the Natural Motion Controller, and of exemplary methods for implementing the program modules described in Section 1 with respect to FIG. 1. In particular, the following sections provides examples and operational details of various implementations of the Natural Motion Controller, including:
An operational overview of the Natural Motion Controller;
Exemplary machine-learning techniques adapted for use in training the motion sequence model;
Adaptation and use of trained models for natural motion-based control;
Exemplary control motions; and
Exemplary form factors for user worn control devices.

2.1 Operational Overview:

As noted above, the Natural Motion Controller described herein provides various techniques for identifying motions of one or more parts of a user's body to interact with computing devices and electronically controlled or actuated devices or machines, thereby enabling various NUI scenarios. In various implementations, the capabilities of the Natural Motion Controller are based on data from inertial sensors, including accelerometers and gyroscopes embedded in, coupled to, or otherwise associated with one or more worn, carried, or held mobile computing devices. The sensor data received from such devices is evaluated to obtain model-based probabilistic inferences to identify particular motions, or motion sequences, of user body parts, including, but not limited to, fingers, hands, arms, head, eyes, eyelids, mouth, tongue, teeth, torso, legs, feet, etc. Note that for purposes of explanation, body part motions used as the basis for triggering application commands are sometimes referred to herein as “control motions.”

In various implementations, the Natural Motion Controller considers sensor sampling periods, which include sensor data such as current acceleration and angular velocity of a user worn control device associated with a particular body part, to form a “frame.” N consecutive frames form a composite motion recognition window, where N is a fixed or adjustable parameter. The composite motion recognition window is then provided to the machine-learned motion sequence model to obtain a recognition result representing a predefined motion of a particular user body part, with that recognition result then being used to trigger execution of a sequence of one or more application commands. Examples of techniques used to train the machine-learned motion sequence model include, but are not limited to support vector machines (SVM), deep neural networks (DNN), recurrent neural networks (RNN), etc.

Depending on the model structure, different types of sensor data may be provided. For example, RNN-based models may be applied directly to a stream of input frames other than fixed length windows or sampling periods. In various implementations, for each recognition window, the sensory data is represented by a feature vector (assuming SVM- and DNN-based models) or a sequence of feature vectors (assuming RNN-based models). The models then take these feature representations as input and compute a prediction output (i.e., the recognition result), which represents the predicted motion or sequence of motions.

Given the predicted motions and corresponding triggering of application commands, the Natural Motion Controller provides interaction and control of any desired communications capable computing devices and electronically controlled or actuated devices or machines. In various implementations, user worn devices, such as smartwatches for example, may be controlled in response to body motion based on data from inertial sensors embedded in the smartwatch device itself. Such implementations enable one-hand no-touch control of the device. For example, in various implementations, a user twist of the wrist on which the smartwatch is worn is sufficient to produce an identifiable motion of the wrist that triggers an application command, such as, for example, enabling a microphone integral to the smartwatch to receive voice commands from the user.

Consequently, in contrast to techniques that require users to interact with a touchscreen or the like to control devices such as smartwatches, the Natural Motion Controller frees the user from using her hands or fingers to physically touch the device for interaction purposes, thereby significantly improving user productivity, and often user safety. For example, consider the case where a user is carrying items in both hands. In such cases, simple user motions will enable control and interaction with the smartwatch (or other computing devices and electronically controlled or actuated devices) without requiring the user to release the items she is carrying to use her fingers to interact with that device. Similarly, consider the case where a user is driving a car and wearing a smartwatch-based phone on his wrist. In such cases, the user can initiate or receive calls via the smartwatch-based phone through simple physical motions (e.g., wrist twist, tap fingers on the steering wheel, etc.), thereby eliminating any need to look away from the road or release the steering wheel to interact with the smartwatch while driving, thereby improving user safety.

2.2 Exemplary Machine-Learning Techniques:

The following paragraphs provide examples of a few machine-learning and modeling techniques that may be adapted for use by the Natural Motion Controller. It should be understood that the Natural Motion Controller is not intended to be limited to the particular examples of machine-learning and modeling techniques discussed below, and that these examples are provided only for purposes of discussion and explanation.

2.2.1 SVM Modeling Techniques:

Support vector machines (SVMs) are a type of classifier that takes as input a feature vector xεRⁿ and computes an output class label y. In the standard binary classification formulation yε{+1, −1}, and for each x the prediction (that in the case of the Natural Motion Controller represents predicted body part motions) is computed as sign(w^{T}x) where w is a parameter vector. The model parameter w is learned using a set of labeled (x, y) pairs to minimize a regularized loss function as illustrated by Equation 1, where:

$${min}_{w} \frac{1}{2} {\vert w \vert}^{2} + {\sum }_{i} l ( {y}_{i} , {w}^{T} {x}_{i} ) \qquad Equation 1$$

where l is usually the hinge loss l(yᵢ,w^{T}xᵢ)=max{0, 1−yᵢw^{T}xᵢ}. For a convex loss like the hinge loss, this objective is a convex function and can be optimized efficiently using many convex optimization methods. After learning, the parameter w is used in the recognition system. Note that in the case of the Natural Motion Controller, the labeled (x, y) pairs represent positively and negatively labeled examples corresponding to predefined user body part motions.

SVM can also be extended to the nonlinear case by the use of a kernel function, and to the multi-class case by using strategies like 1-versus-all, or by using a structured multi-class loss.

2.2.2 DNN Modeling Techniques:

Deep neural networks (DNNs) are a type of nonlinear classifier. When making a prediction (that in the case of the Natural Motion Controller represents a class label corresponding to predicted body part motions), DNNs pass an input vector x (in this case representing inertial sensor data) through multiple layers of nonlinear transformations and finally into a class label.

In general, typical DNN architectures include a plurality of nonlinear layers, also called hidden layers or neurons. For each layer, an input vector is mapped to an output vector. For example, in layer n, the input vector hⁿ is mapped to the output vector hⁿ⁺¹ as:

$${h}_{j}^{n + 1} = f ( {b}_{j}^{n} + {\sum }_{i} {w}_{ij}^{n} {h}_{i}^{n} ) \qquad Equation 2$$

where bⁿ and wⁿ are parameters for this layer and ƒ is a nonlinearity function. For the input layer (i.e., layer 0), h⁰=x, (i.e., the sensor data). Common choices for ƒ include, but are not limited to, a logistic function such as

$$( x ) = \frac{1}{1 + {e}^{- x}} ,$$

a hyperbolic tangent or “tan h” function such as

$$f ( x ) = \frac{{e}^{x} - {e}^{- x}}{{e}^{x} + {e}^{- x}} ,$$

a rectified linear function such as ƒ(x)=max{0,x}, and the like.

The output layer is usually, but not necessarily, a softmax-type function or the like, that models the conditional probability distribution of the class label as:

$$p ( y = k \vert x ) = \frac{exp ( {b}_{k} + {\sum }_{i} {w}_{ik} {h}_{i}^{N} )}{{\sum }_{{k}^{′}} exp ( {b}_{{k}^{′}} + {\sum }_{i} {w}_{{ik}^{′}} {h}_{i}^{N} )} \qquad Equation 3$$

where N is the number of layers in the network. The final prediction is computed as illustrated by Equation 4, where:

y*=argmaxₖp(y=k|x) Equation 4

DNNs are often trained to minimize a loss function defined on a set of training (xₜ, yₜ) pairs (that in the case of the Natural Motion Controller represent positively and negatively labeled examples corresponding to predefined user body part motions). For example, the negative log-likelihood loss function of Equation 5 may be used for such purposes, where:

$${min}_{w , b} - {\sum }_{t} log p ( {y}_{t} \vert {x}_{t} ) \qquad Equation 5$$

2.2.3 RNN Modeling Techniques:

Recurrent Neural Networks (RNNs) are a type of neural network designed for sequential data. Typical RNN-based architectures consist of an input layer at the bottom, one or more hidden layers in the middle with recurrent connections between hidden layers at different times, and an output layer at the top. Each layer represents a set of neurons, and the layers are connected with weights U and V. The input layer xₜ represents input signal at time t, and the output layer yₜ produces a probability distribution over class labels. The hidden layers hₜ maintain a representation of the sensor data history. The input vector xₜ is the feature representation for frame t (or a context around frame t). The output vector yₜ has a dimensionality equal to the number of possible motions. The values in the hidden and output layers are computed as follows:

hₜ=ƒ(Uxₜ+Whₜ₋₁)

yₜ=g(Vhₜ) Equation 6

where ƒ and g are element-wise nonlinearities. Usually g is a softmax function and ƒ can be any desired sigmoid nonlinearity function.

The RNN-based model is trained using standard back-propagation to maximize the data conditional likelihood:

$${\prod }_{t} p ( {y}_{t} \vert {x}_{1} , … , {x}_{t} ) \qquad Equation 7$$

Note that this model has no direct interdependence between output variables across time. Thus, the most likely sequence of output labels can be computed with a series of online decisions:

yₜ*=argmax p(yₜ|x₁, . . . ,xₜ) Equation 8

This has the advantage of being online and very efficient, and is faster than the dynamic programming search method for other sequence labeling models.

2.2.4 LSTM Modeling Techniques:

Long-Short Term Memory (LSTM) models are an extension of the standard RNN model that uses gating units to modulate the input, output and hidden-to-hidden transitions. By using gating units, the hidden units of LSTMs can keep track of a longer history and therefore usually provide improved modeling of long-range dependencies.

Typical LSTM architectures implement the following operations:

iₜ=σ(Wₓᵢxₜ+Wₕᵢhₜ₋₁+W_{ci}cₜ₋₁+bᵢ)

fₜ=σ(W_{xf}xₜ+W_{hf}hₜ₋₁W_{cf}Cₜ₋₁b_{f})

cₜ=fₜ⊙cₜ₋₁+iₜ⊙ tan h(W_{xc}xₜ+W_{hc}hₜ₋₁+b_{c})

oₜ=σ(Wₓ₀xₜWₕᵢhₜ₋₁W_{c0}cₜb₀)

hₜ=oₜ⊙ tan h(cₜ) Equation 9

where iₜ, oₜ, and fₜ are input, output and forget gates respectively. Memory cell activity is cₜ. Further, xₜ and hₜ are the input and output of the LSTM, respectively. Element wise product is denoted as ⊙. σ represents a logistic sigmoid function. The output hₜ of LSTM is then passed to the output of the model to generate the predicted result (that in the case of the Natural Motion Controller represents predicted body part motions), as illustrated by Equation 10, where:

tₜ=Softmax(W_{hy}hₜ+b_{y}) Equation 10

In general, LSTMs differ from RNNs in that recurrent connections are between linear memory cell activities, and gates are used to modulate inputs, to discard past memory activities and to adjust outputs. However, as with standard RNNs, LSTMs are also trained to optimize the conditional likelihood and can make online predictions.

2.3 Adaptation and Use of Models for Natural Motion Control:

In various implementations, the process for training the machine-learned motion sequence model, using any desired machine-learning technique, typically includes a data collection process. This data collection process involves tasking multiple users to perform particular predefined motions representing a plurality of positive training examples and a plurality of other motions, including arbitrary motions, representing negative training examples. This process is used to collect sensor data from the control devices worn, held, or carried, by multiple users while users are performing the tasked motions. The collected data, representing both positively and negatively labeled training examples from multiple different users are then pooled and used to train a single motion model that works well across all users to identify user body part motions, or sequences of motions, from a set of predefined user motions.

Note that model performance may be enhanced by reducing false positive motion identifications by using larger numbers of negative examples than positive examples when training the model. For example, negative examples can be collected from particular motions that are intended to be explicitly excluded. For example, when a user puts his hand into his pocket, he may twist your wrist as part of the overall motion. However, assuming that a twist motion is typically intended to represent a predefined motion for triggering application commands, it would be desired to exclude the overall sequence of placing a hand in the pocket. In this case, inertial sensor data for the entire sequence of the user putting his hand into his pocket along with a wrist twist would be collected as a negative example for model training purposes.

In various implementations, the machine-learned motion sequence model is trained in several progressive stages. For example, an initially trained model can be run against inertial sensor data while one or more users perform a variety of motions. Then, whenever any motion sequence triggers false positive, use that motion sequence is captured and used as a negative example to retrain a progressively more accurate instance of the model. In other words, additional training data may be collected by running partially trained models.

In various implementations, users indicate correct or incorrect (or equivalent status indicators) whenever a body part motion is identified by the model based on some user motion sequence. The corresponding motion sequence will then be labeled as positive or negative and used to retrain a subsequent instance of the model. Note that multiple additional positive and negative examples from multiple users are used in this model updating or retraining process, and that multiple iterations of such training may be performed to generate models of increasing accuracy.

Similarly, in various implementations, in the event that the Natural Motion Controller returns an incorrect prediction as to a user body part motion and thereby triggers an incorrect application command, a user interface mechanism is available to stop or undue that application command. The corresponding motion sequence may then be labeled as a negative example and used to retrain a subsequent instance of the model. Further, in the event that the Natural Motion Controller returns an incorrect prediction as to a user body part motion, the user may then either adjust his motions to those expected by the model, or may provide additional positive and/or negative examples to help retrain the model to recognize or identify the particular motions of that user.

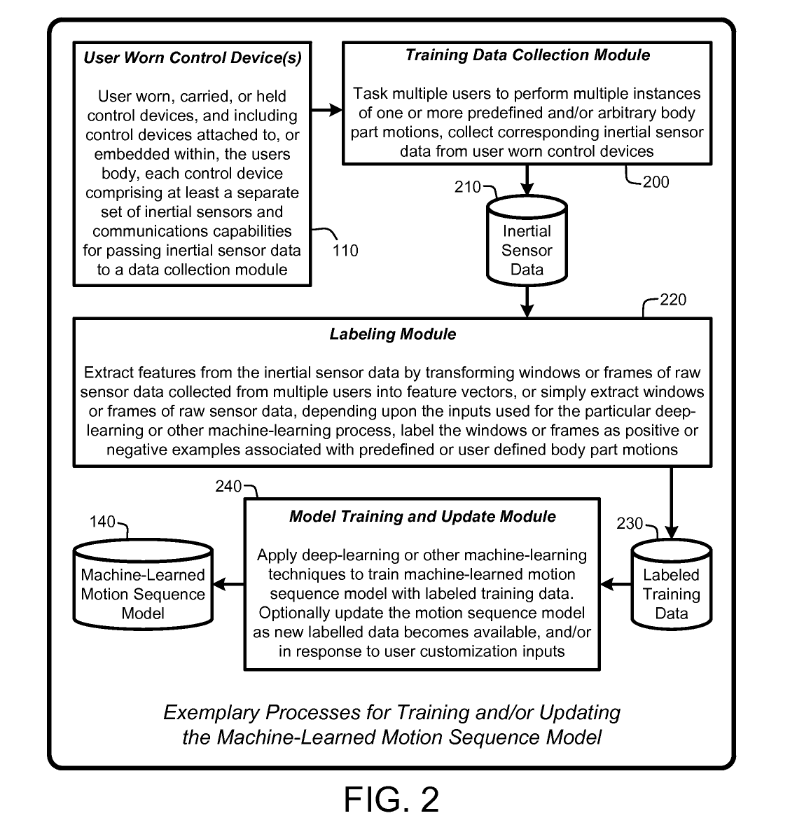

FIG. 2 illustrates an exemplary high-level overview for training machine-learned motion sequence models. Note that FIG. 2 is intended to be understood in view of the preceding discussion, and in further view of the following discussions regarding training data collection (see Section 2.3.1), feature extraction (see Section 2.3.2), incorporation of context dependencies (see Section 2.3.3), optional post processing (see Section 2.3.4), and updating models on a per-user bases (see Section 2.3.5). Further, FIG. 2 is not intended to provide a complete illustration or discussion of the various deep learning or other machine-learning techniques that may be adapted for use in training the machine-learned motion sequence model.

In general, the exemplary model training processes illustrated by FIG. 2 begins operation by applying a training data collection module 200 that tasks multiple users to perform multiple instances of one or more predefined and/or arbitrary body part motions. The training data collection module 200 then collects corresponding inertial sensor data 210 from the user worn control devices 110 (described with respect to FIG. 1).

A labeling module 220 then extracts features from the inertial sensor data 210 by transforming windows or frames of the raw sensor data into feature vectors, or by simply extracting windows or frames of raw sensor data, depending upon the types of inputs used for the particular deep-learning or other machine-learning process. The labeling module 220 then label the windows or frames as positive or negative examples associated with predefined or user defined body part motions. The result of these processes is a set of labeled training data 230 that is then passed to a model training and update module 240 applies deep-learning or other machine-learning techniques to the train machine-learned motion sequence model 140 on the labeled training data. In various implementations, the model training and update module 240 optionally updates the motion sequence model as new labelled data becomes available, and/or in response to user customization inputs, as discussed in further detail in the following paragraphs.

2.3.1 Training Data Collection:

In general, training data can be collected using any desired data collection scenario for generating positive and negative labeled training examples. For example, in various implementations of the Natural Motion Controller, training data may be collected using a wearable or mobile device with inertial sensors. In such implementations, streams of incoming sensor data for sets of inertial sensors associated with particular user worn control devices are recorded while users are directed to perform specific motions. Once that motion has been completed, the user is directed to indicate completion of the motion through means including, but not limited to, pressing a button, clicking on the screen to signal the end of the motion, speaking a word or sequence of words, such as “motion complete,” etc. These completion events are also recorded. Then, during training, a few windows of frames before each completion event are labeled as positive training data for the motions, and windows sampled from other periods are used as negative background training data.

2.3.2 Feature Extraction:

Feature extraction transforms a window of raw sensory data frames into a feature vector suitable to be used by machine-learned motion sequence models trained using techniques including SVM- and DNN-based methods. In various implementations of the Natural Motion Controller, feature vectors including, but not limited to, moving average, wavelet features and normalized raw data, were extracted from the raw inertial sensor data.

2.3.3 Incorporating Context Dependencies:

As noted above, in various implementations, the machine-learned motion sequence model is trained on data (or feature vectors) received from various sensors while users are performing one or more known motions. This training data is then used as input features for model training. Further, in various implementations, the Natural Motion Controller optionally adapts any desired machine learning and modeling techniques to incorporate context-dependency.

For example, when preparing input features for each frame in RNN and LSTM-based motion sequence models, the Natural Motion Controller may apply a context window instead of a single frame as input, which can make the predictions for each frame more accurate and robust. For example, by denoting a context length as L, the input for time t is [x_{t-L}, x_{t-L+1}, . . . , xₜ, . . . , x_{t+L-1}, x_{t+L}]. The resulting context window is then used to implement a feature extraction process that transforms each window or frame of raw sensory data into feature vectors for machine-learned motion sequence model. These feature vectors are then provided as input to the machine-learned motion sequence model for use in computing predicted motions as outputs. In addition, in various implementations, a post-processing operation is applied to further smooth the motion predictions.

2.3.4 Post-Processing:

The pipeline described above results in a machine-learned motion sequence model that is capable of predicting a motion class label (i.e., the user body part motion) for each window (for SVMs and DNNs) or for each frame (RNNs and LSTMs). In various implementations, to further smooth the predictions and make them more robust, an extended prediction window is optionally used to buffer the prediction results from each of some relatively small number of preceding windows or frames. Then, a dominant prediction over the extended prediction window (e.g., the prediction resulting from two of three sequential windows or frames comprising the extended prediction window result in the same predicted body part motion) may be used output as the most probable motion for use in triggering application commands.

2.3.5 Updating Models on a Per-User Basis:

In various implementations, performance of the machine-learned motion sequence model is further improved by adjusting model weights to increase model sharpness with respect to particular body part motions. In other words, if two different body part motion predictions by the motion sequence model have similar probabilities or scores based on a particular motion sequence, then the model may toggle between those predictions in response to slightly different user motions. In such cases, further training may be applied to the motion sequence model to increase the contrast between those scores or probabilities. This additional training will ensure consistency so that different body part motion sequences are not detected at different times when the user attempts the same motion sequence as a result of natural variations in the sequence. One way in which this is accomplished is to reinforce or increase weights in the model sequence model that are associated with particular body part motion sequences when the user repeatedly performs motions associated with those particular body part motion sequences. In other words, model weights are adapted to reinforce outputs corresponding to common or frequent user body part motions.

Similarly, in various implementations, motion sequence models are automatically adapted to patterns of particular users. For example, in various implementations, a user feedback mode or the like provides additional positive and/or negative examples that are used to retrain or otherwise update the motion sequence model on a per-user basis. In other words, in various implementations, if the model is not providing acceptable results for a particular user, the Natural Motion Controller may task the user to perform one or more instances of motion sequences that represent particular positive examples (i.e., positive labeled examples) or negative examples (i.e., negative labeled examples).

More specifically, adapting the motion sequence models for individual users involves collecting additional training data for those particular users. The basic concept here is that given a trained motion sequence model being applied to the motions (i.e., inertial sensor data) of a particular user, the Natural Motion Controller will continue to collect data from that user for use in updating and retraining the model. In various implementations, this data collection also involves tasking the user to perform particular body part motion sequences to collect additional sensor data. Further, in various implementations, the user is tasked to indicate whenever a false positive has triggered, with the corresponding sensor data then being used as a negative example. In other words, the predictive behavior of the motion sequence model may be increasingly adapted to individual users over time by updating the model with inertial sensor data corresponding to user-specific motion sequences.

In general, the trained motion sequence model comes with a set predefined motion sequences. However, in various implementations, the Natural Motion Controller allows the user to add or create new or customized motion sequences and corresponding activation commands. Similarly, in various implementations, the Natural Motion Controller allows the user to remove and/or edit existing motion sequences and corresponding activation commands. In other words, in various implementations, each user can define his own motion sequences and associated activation commands, thereby ensuring that the Natural Motion Controller is fully customizable on a per-user basis.

In addition to updating motion sequence models on a per-user basis, in various implementations, inertial sensor data corresponding to body part motions of individual anonymized users can be uploaded to a server or cloud service and used to retrain a new multi-user motion sequence model that is then pushed or propagated back to other users.

In various implementations, retraining or updates to the motion sequence model may be performed locally using computational capabilities available to individual users. Alternately, or in combination, in various implementations, retraining or updates to the motion sequence model may be performed by sending labeled positive and negative examples of inertial sensor data associated with user motion sequences of one or more users to a remote server or cloud-based system for remote model updates. The resulting updated motion sequence model may then be propagated back to one or more users.

Note that in any of the update scenarios described above, frequency of motion sequence model updates or tuning can be set to any desired period (i.e., hourly, daily, weekly, etc.). Similarly, motion sequence model updates, retraining, or tuning can be performed on an on-demand basis whenever it is desired to improve model performance.

2.4 Exemplary Control Motions:

In general, the machine-learned motion sequence model may be trained to recognize motions, or sequences of multiple motions, of any user body parts. Further, any user body part motion, or sequence of motions, that can be identified by the motion sequence model may be used to trigger application commands for initiating any desired response or behavior in any user worn control device or in any other computing device or electronically controlled or actuated device or machine. As such, it should be understood that the exemplary control motions discussed in the following paragraphs, and any control motions discussed throughout this document represent a mere fraction of the virtually limitless combinations of control motions and corresponding application commands that may be triggered by the Natural Motion Controller in response to those control motions. Consequently, none of the described control motions and none of the described application commands are intended to limit the scope of control motions and application commands that may be defined or designated for use with the Natural Motion Controller.

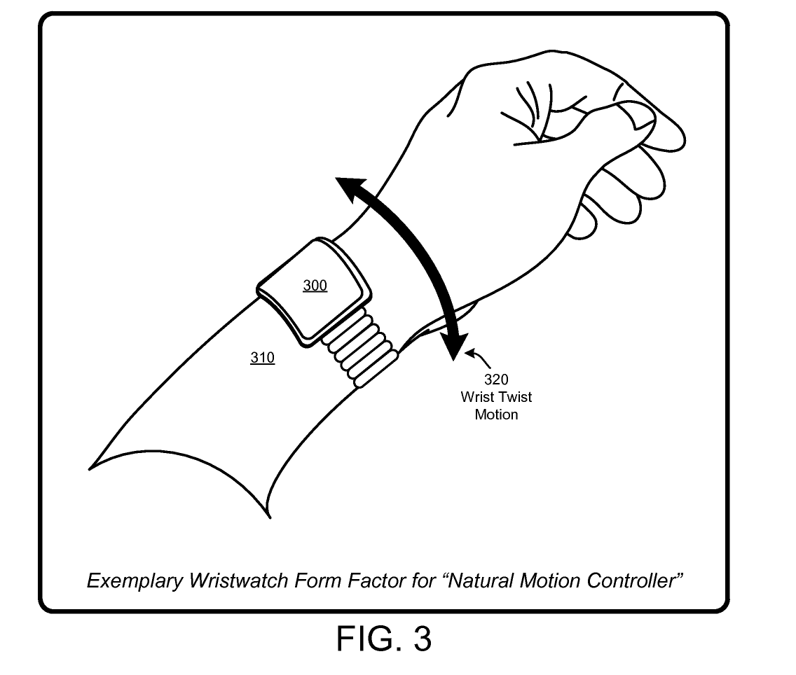

In view of the preceding discussion, a few exemplary predefined body part motions and motion sequences identifiable by the motion sequence model from corresponding inertial sensor data are summarized below for purposes of explanation and discussion:
1. Wrist twist or shake. For example, FIG. 3 illustrates a user-worn control device in a smartwatch form factor 300 worn on a user's left wrist 310. FIG. 3 further illustrates an axial twist 320 of the user's left wrist 310 (where the twisting motion is indicated by the heavy curved double-sided arrow);
2. Finger tap;
3. Hand clap;
4. Snapping fingers;
5. Waving hand;
6. Move or swing arm;
7. Blink eyelids;
8. Move eyes;
9. Click or grind teeth;
10. Open or close mouth;
11. Rotate head;
12. Tilt head;
13. Nod or shake head;
14. Twist torso;
15. Hand shake with another user;
16. Fist bump with another user;
17. Foot stomp;
18. Consecutive number of user steps;
19. Etc.

In view of the preceding discussion, a few exemplary application commands triggered in response to predefined motions and motion sequences are summarized below for purposes of explanation and discussion:
1. Detect predefined body part motion or motion sequence Start or execute application command;
2. Detect predefined body part motion or motion sequence Switch to another session or window in an application;
3. Detect predefined body part motion or motion sequence Send message;
4. Detect predefined body part motion or motion sequence Turn on microphone;
5. Detect predefined body part motion or motion sequence Initiate communications device (e.g., answer or make call using cell phone or other communications device);
6. Detect predefined body part motion or motion sequence Control external devices (e.g., wave arm towards television, camera sees television, inertial sensors detect motions, Natural Motion Controller turns television on or off depending on current state).

2.4.1 Synchronized Control Motions between Multiple Users:

In various implementations, the Natural Motion Controller automatically detects intentional synchronization (as a function of time and/or proximity) between body part motions or motion sequences between two or more users. Such synchronized motions or motion sequences are then used in a manner similar to identified control motions of individual users to trigger application commands.

For example, consider the case of two or more users each wearing a control device in a form factor such as a smartwatch, bracelet, ring, etc. In such cases, any predefined user body part motions, such as, for example, user fist-bumps, high-fives, shake hands, etc., that are determined to be synchronized may be used to initiate or trigger application commands. For example, identification of synchronized user motions such as a hand shake between two users may automatically initiate an exchange of data or contact information such as name, phone numbers, etc., between computing or storage devices associated with those users. Note that in such cases, users may optionally set or adjust a privacy profile to either enable or disable such sharing, and may set options such as providing such data as long as the other user is also sharing such data in return.

2.4.2 Exemplary Usage Scenarios:

In view of the preceding discussion, a few exemplary usage scenarios are summarized below for purposes of explanation and discussion:
1. Users performing motions or motion sequences to control applications;
2. User worn control devices interacting with, or controlling, other worn, carried, or external devices (e.g., phones, tape recorders, lights, televisions, etc.) in response to identified motions or motion sequences;
3. Interaction between multiple users in response to synchronized motions or motion sequences. For example, ten users in a huddle or group triggers or initiates data sharing, syncs communications, syncs electronic calendars, etc., between all users in that group (optionally subject to individual privacy settings of individual users);
4. Motions or motion sequences of multiple different users interact to initiate a single application command or sequence of commands. For example, if a majority, or some predefined threshold number, of different users perform a predefined motion sequence (e.g., three of four users each twist their wrist), that shared motion sequence may be used to trigger execution of a predefined or user defined application command. For example, in a group of twelve users, assuming that seven of the twelve make a thumbs up motion identified by the motion model, while five of those users make a thumbs down motion, an application command intended by the seven-user majority of the group may be triggered; and
5. Multiple control devices (and the corresponding inertial sensors) may also be placed on (or in) the user's body to capture motion of hands, arms, legs, torso, head, etc., with any identified motions then also being used for skeleton tracking. For example, wrist or hand worn control devices with inertial sensors may be used to track motions of the user and to then replicate those motions in a game. For example, consider a boxing game where hands of a digital avatar mimic those of the user based on user hand and arm motions identified by the motion sequence model from inertial sensor data. Advantageously, such implementations result in significantly reduced computational overhead compared to visual tracking of the users body or body parts to enable skeleton tracking-based applications.

2.4.3 Combination with Additional Sensors:

In various implementations, the Natural Motion Controller combines the inertial sensor data with sensor data received from one or more additional optional sensors. For example, inertial sensors typically include sensor devices including, but not limited to, accelerometers and gyroscopes. However, additional sensors, including, but not limited to, cameras, laser-based devices, light sensors, proximity sensors (e.g., how close is user or control device to body or other devices), etc.

These additional optional sensors are used in various implementations to augment or control application commands triggered in response to motions identified via data received from inertial sensors. For example, a particular predefined body part motion sequence may trigger one application command in bright light, but trigger another application command (or prevent triggering of an application command) in low light. As another example, various sensors may be used to determine that a user is in a water environment (e.g., pool, river, lake, ocean, etc.) and may then cause the Natural Motion Controller Waterproof to identify user swimming motions for a variety of purposes.

2.5 Exemplary Form Factors for User Worn, Carried or Held Devices:

As discussed throughout this document, a machine learned motion sequence model of the Natural Motion Controller considers inertial sensor data received from body worn control devices to predict or identify user body part motions or motion sequences. These user worn control devices may be implemented in any of a wide range of form factors. Further, depending upon the form factor, those control devices may be worn on the user's body, coupled to the user's body, and/or implanted or otherwise inserted into the user's body. In view of these considerations, a few exemplary control device form factors (each containing at least one or more inertial sensors and capabilities for communicating sensor data to the Natural Motion Controller) are summarized below for purposes of explanation and discussion:
1. Wristwatches;
2. Wristbands;
3. Smartwatches;
4. Eyeglasses;
5. Contact lenses (with integral inertial sensors to detect eye blink motions or other eye motions or motion sequences);
6. Shirts, pants, jackets, dresses, or other clothing items;
7. Belts;
8. Shoes;
9. Bracelets, broaches, necklaces, rings, earrings, or other jewelry;
10. Veneers or coverings on, or inside, teeth, fingers, fingernails, etc. For example, inertial sensors attached to fingernail allow user to tap fingers as a predefined motion to trigger one or more application commands;
11. Dental implants (e.g., replace one or more teeth with control devices). Also optionally include additional functionality such as a miniaturized cell phone or communications capabilities. Use such control devices, for example, by identifying user clicking teeth one or more times as a predefined motion or motion sequence to enable communications;
12. Body piercings;
13. Body implants (e.g., small inertial sensors placed in or on the body);
14. Mouth guard (e.g., evaluate head or teeth motions while playing sports or sleeping. For example, identify motions corresponding to user grinding his teeth while sleeping, and initiate one or more application commands in response;
15. Etc.

### 3.0 Operational Summary of the Natural Motion Controller

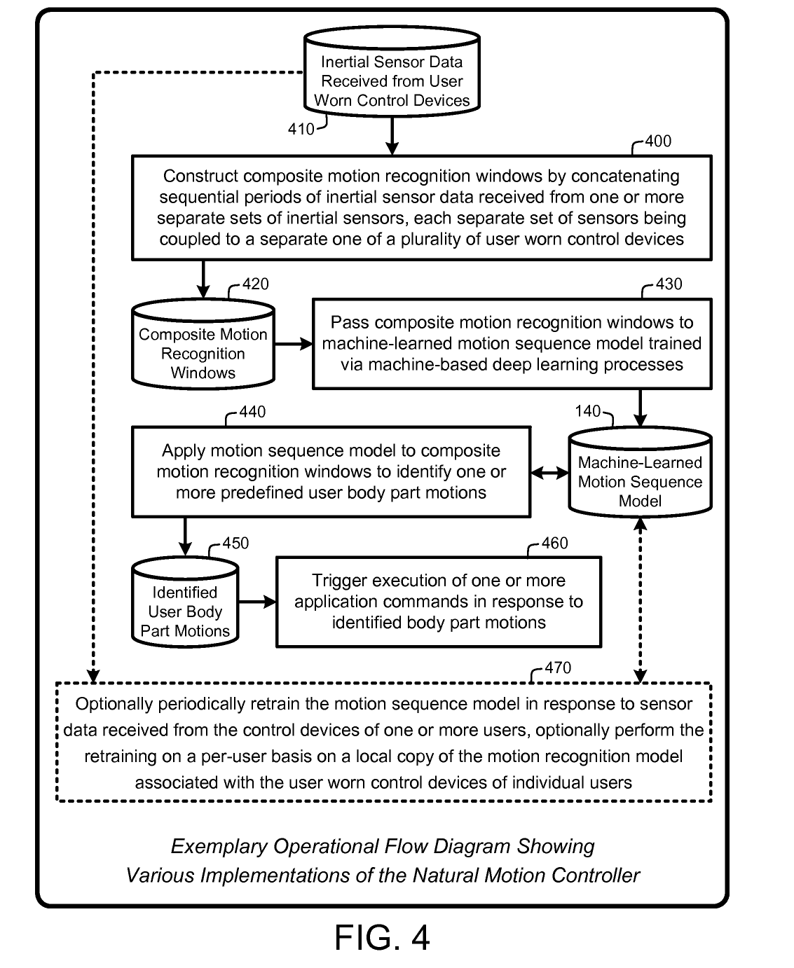

The processes described above with respect to FIG. 1 through FIG. 3, and in further view of the detailed description provided above in Sections 1 and 2, are illustrated by the general operational flow diagram of FIG. 4. In particular, FIG. 4 provides an exemplary operational flow diagram that summarizes the operation of some of the various implementations of the Natural Motion Controller. Note that FIG. 4 is not intended to be an exhaustive representation of all of the various implementations of the Natural Motion Controller described herein, and that the implementations represented in FIG. 4 are provided only for purposes of explanation.

Further, it should be noted that any boxes and interconnections between boxes that are represented by broken or dashed lines in FIG. 4 represent optional or alternate implementations of the Natural Motion Controller described herein, and that any or all of these optional or alternate implementations, as described below, may be used in combination with other alternate implementations that are described throughout this document.

In various implementations, as illustrated by FIG. 4, the Natural Motion Controller begins operation by constructing 400 a composite motion recognition window 420 by concatenating an adjustable number of sequential periods of inertial sensor data 410 received from one or more separate sets of inertial sensors, each separate set of inertial sensors being coupled to a separate one of a plurality of user worn control devices. The Natural Motion Controller then passes the composite motion recognition window 420 to the aforementioned machine-learned motion sequence model 140 (also referred to herein as a “motion recognition model”) that has been trained by one or more machine-based deep learning processes.

The Natural Motion Controller then applies 440 the machine-learned motion sequence model 140 to the composite motion recognition window 420 to identify a sequence of one or more predefined motions 450 of one or more user body parts. The Natural Motion Controller then triggers 460 execution of a sequence of one or more application commands in response to the identified sequence of one or more predefined motions.

Further, in various implementations, the Natural Motion Controller optionally periodically retrains 470 the motion sequence model in response to sensor data received from the control devices of one or more users. In addition, the Natural Motion Controller optionally performs this retraining on a per-user basis on a local copy of the motion recognition model associated with the user worn control devices of individual users.

### 4.0 Exemplary Operating Environments

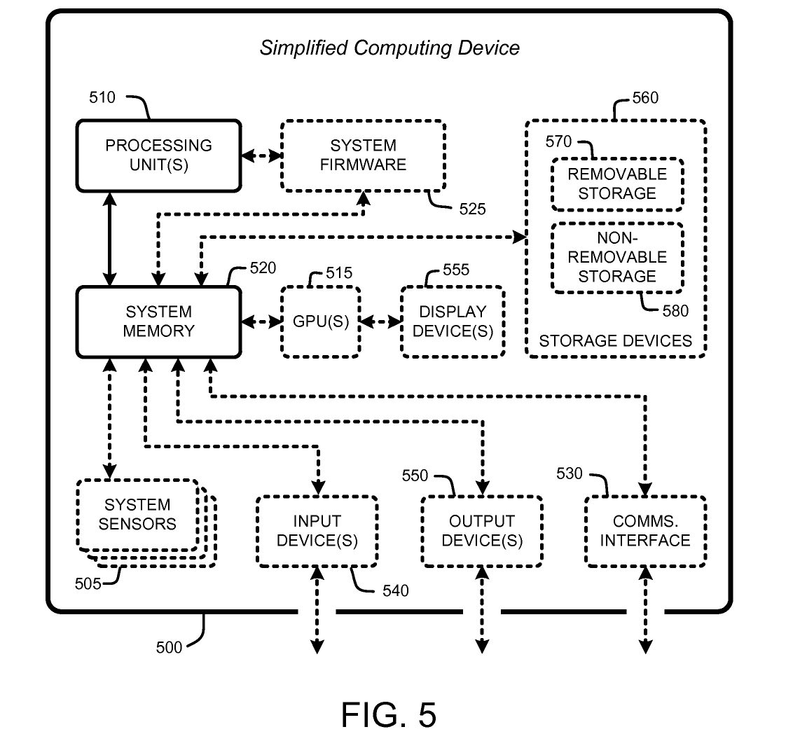

The Natural Motion Controller implementations described herein are operational within numerous types of general purpose or special purpose computing system environments or configurations. FIG. 5 illustrates a simplified example of a general-purpose computer system on which various implementations and elements of the Natural Motion Controller, as described herein, may be implemented. It is noted that any boxes that are represented by broken or dashed lines in the simplified computing device 500 shown in FIG. 5 represent alternate implementations of the simplified computing device. As described below, any or all of these alternate implementations may be used in combination with other alternate implementations that are described throughout this document.

The simplified computing device 500 is typically found in devices having at least some minimum computational capability such as personal computers (PCs), server computers, handheld computing devices, laptop or mobile computers, communications devices such as cell phones and personal digital assistants (PDAs), multiprocessor systems, microprocessor-based systems, set top boxes, programmable consumer electronics, network PCs, minicomputers, mainframe computers, and audio or video media players.

To allow a device to realize the Natural Motion Controller implementations described herein, the device should have a sufficient computational capability and system memory to enable basic computational operations. In particular, the computational capability of the simplified computing device 500 shown in FIG. 5 is generally illustrated by one or more processing unit(s) 510, and may also include one or more graphics processing units (GPUs) 515, either or both in communication with system memory 520. Note that that the processing unit(s) 510 of the simplified computing device 500 may be specialized microprocessors (such as a digital signal processor (DSP), a very long instruction word (VLIW) processor, a field-programmable gate array (FPGA), or other micro-controller) or can be conventional central processing units (CPUs) having one or more processing cores and that may also include one or more GPU-based cores or other specific-purpose cores in a multi-core processor.

In addition, the simplified computing device 500 may also include other components, such as, for example, a communications interface 530. The simplified computing device 500 may also include one or more conventional computer input devices 540 (e.g., touchscreens, touch-sensitive surfaces, pointing devices, keyboards, audio input devices, voice or speech-based input and control devices, video input devices, haptic input devices, devices for receiving wired or wireless data transmissions, and the like) or any combination of such devices.

Similarly, various interactions with the simplified computing device 500 and with any other component or feature of the Natural Motion Controller, including input, output, control, feedback, and response to one or more users or other devices or systems associated with the Natural Motion Controller, are enabled by a variety of Natural User Interface (NUI) scenarios. The NUI techniques and scenarios enabled by the Natural Motion Controller include, but are not limited to, interface technologies that allow one or more users user to interact with the Natural Motion Controller in a “natural” manner, free from artificial constraints imposed by input devices such as mice, keyboards, remote controls, and the like.

Such NUI implementations are enabled by the use of various techniques including, but not limited to, using NUI information derived from user speech or vocalizations captured via microphones or other input devices 540 or system sensors 505. Such NUI implementations are also enabled by the use of various techniques including, but not limited to, information derived from system sensors 505 or other input devices 540 from a user's facial expressions and from the positions, motions, or orientations of a user's hands, fingers, wrists, arms, legs, body, head, eyes, and the like, where such information may be captured using various types of 2D or depth imaging devices such as stereoscopic or time-of-flight camera systems, infrared camera systems, RGB (red, green and blue) camera systems, and the like, or any combination of such devices.

Further examples of such NUI implementations include, but are not limited to, NUI information derived from touch and stylus recognition, motion and gesture recognition (both onscreen and adjacent to the screen or display surface), air or contact-based motions and gestures, user touch (on various surfaces, objects or other users), hover-based inputs or actions, and the like. Such NUI implementations may also include, but are not limited to, the use of various predictive machine intelligence processes that evaluate current or past user behaviors, inputs, actions, etc., either alone or in combination with other NUI information, to predict information such as user intentions, desires, and/or goals. Regardless of the type or source of the NUI-based information, such information may then be used to initiate, terminate, or otherwise control or interact with one or more inputs, outputs, actions, or functional features of the Natural Motion Controller.

However, it should be understood that the aforementioned exemplary NUI scenarios may be further augmented by combining the use of artificial constraints or additional signals with any combination of NUI inputs. Such artificial constraints or additional signals may be imposed or generated by input devices 540 such as mice, keyboards, and remote controls, or by a variety of remote or user worn devices such as accelerometers, electromyography (EMG) sensors for receiving myoelectric signals representative of electrical signals generated by user's muscles, heart-rate monitors, galvanic skin conduction sensors for measuring user perspiration, wearable or remote biosensors for measuring or otherwise sensing user brain activity or electric fields, wearable or remote biosensors for measuring user body temperature changes or differentials, and the like. Any such information derived from these types of artificial constraints or additional signals may be combined with any one or more NUI inputs to initiate, terminate, or otherwise control or interact with one or more inputs, outputs, actions, or functional features of the Natural Motion Controller.

The simplified computing device 500 may also include other optional components such as one or more conventional computer output devices 550 (e.g., display device(s) 555, audio output devices, video output devices, devices for transmitting wired or wireless data transmissions, and the like). Note that typical communications interfaces 530, input devices 540, output devices 550, and storage devices 560 for general-purpose computers are well known to those skilled in the art, and will not be described in detail herein.

The simplified computing device 500 shown in FIG. 5 may also include a variety of computer-readable media. Computer-readable media can be any available media that can be accessed by the computing device 500 via storage devices 560, and include both volatile and nonvolatile media that is either removable 570 and/or non-removable 580, for storage of information such as computer-readable or computer-executable instructions, data structures, program modules, or other data.

Computer-readable media includes computer storage media and communication media. Computer storage media refers to tangible computer-readable or machine-readable media or storage devices such as digital versatile disks (DVDs), Blu-ray discs (BD), compact discs (CDs), floppy disks, tape drives, hard drives, optical drives, solid state memory devices, random access memory (RAM), read-only memory (ROM), electrically erasable programmable read-only memory (EEPROM), CD-ROM or other optical disk storage, smart cards, flash memory (e.g., card, stick, and key drive), magnetic cassettes, magnetic tapes, magnetic disk storage, magnetic strips, or other magnetic storage devices. Further, a propagated signal is not included within the scope of computer-readable storage media.

Retention of information such as computer-readable or computer-executable instructions, data structures, program modules, and the like, can also be accomplished by using any of a variety of the aforementioned communication media (as opposed to computer storage media) to encode one or more modulated data signals or carrier waves, or other transport mechanisms or communications protocols, and can include any wired or wireless information delivery mechanism. Note that the terms “modulated data signal” or “carrier wave” generally refer to a signal that has one or more of its characteristics set or changed in such a manner as to encode information in the signal. For example, communication media can include wired media such as a wired network or direct-wired connection carrying one or more modulated data signals, and wireless media such as acoustic, radio frequency (RF), infrared, laser, and other wireless media for transmitting and/or receiving one or more modulated data signals or carrier waves.

Furthermore, software, programs, and/or computer program products embodying some or all of the various Natural Motion Controller implementations described herein, or portions thereof, may be stored, received, transmitted, or read from any desired combination of computer-readable or machine-readable media or storage devices and communication media in the form of computer-executable instructions or other data structures. Additionally, the claimed subject matter may be implemented as a method, apparatus, or article of manufacture using standard programming and/or engineering techniques to produce software, firmware 525, hardware, or any combination thereof to control a computer to implement the disclosed subject matter. The term “article of manufacture” as used herein is intended to encompass a computer program accessible from any computer-readable device, or media.

The Natural Motion Controller implementations described herein may be further described in the general context of computer-executable instructions, such as program modules, being executed by a computing device. Generally, program modules include routines, programs, objects, components, data structures, and the like, that perform particular tasks or implement particular abstract data types. The Natural Motion Controller implementations may also be practiced in distributed computing environments where tasks are performed by one or more remote processing devices, or within a cloud of one or more devices, that are linked through one or more communications networks. In a distributed computing environment, program modules may be located in both local and remote computer storage media including media storage devices. Additionally, the aforementioned instructions may be implemented, in part or in whole, as hardware logic circuits, which may or may not include a processor.

Alternatively, or in addition, the functionality described herein can be performed, at least in part, by one or more hardware logic components. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), and so on.

### 5.0 Other Implementations

The following paragraphs summarize various examples of implementations which may be claimed in the present document. However, it should be understood that the implementations summarized below are not intended to limit the subject matter which may be claimed in view of the detailed description of the Natural Motion Controller. Further, any or all of the implementations summarized below may be claimed in any desired combination with some or all of the implementations described throughout the detailed description and any implementations illustrated in one or more of the figures, and any other implementations and examples described below. In addition, it should be noted that the following implementations and examples are intended to be understood in view of the detailed description and figures described throughout this document.

In various implementations, a Natural Motion Controller is implemented by means, processes or techniques for triggering execution of a sequence of one or more application commands in response to an identified sequence of one or more predefined motions of user body parts, thereby increasing user interaction performance and efficiency by enabling users to interact with computing devices by performing body part motions.

As a first example, in various implementations, a computer-implemented process is provided via means, processes or techniques for constructing a composite motion recognition window by concatenating an adjustable number of sequential periods of inertial sensor data received from one or more separate sets of inertial sensors, each separate set of inertial sensors being coupled to a separate one of a plurality of user worn control devices. The composite motion recognition window is then passed to a motion recognition model trained by one or more machine-based deep learning processes. The process then continues by applying the motion recognition model to the composite motion recognition window to identify a sequence of one or more predefined motions of one or more user body parts. The process then continues by triggering execution of a sequence of one or more application commands in response to the identified sequence of one or more predefined motions, thereby increasing user interaction performance and efficiency by enabling users to interact with computing devices by performing body part motions.

As a second example, in various implementations, the first example is further modified via means, processes or techniques for retraining the motion recognition model in response to sensor data received from the control devices of one or more users.

As a third example, in various implementations, the second example is further modified via means, processes or techniques for retraining the motion recognition model is performed a per-user basis on a local copy of the motion recognition model associated with the user worn control devices of individual users.

As a fourth example, in various implementations, any of the first example, the second example, and the third example are further modified via means, processes or techniques for implementing at least one of the plurality of user worn control devices as a wrist worn control device, and wherein the sequence of one or more predefined motions includes a twist of the user's wrist.

As a fifth example, in various implementations, the fourth example is further modified via means, processes or techniques for triggering execution of a communications session of a communications device in response to the twist of the user's wrist.

As a sixth example, in various implementations, any of the first example, the second example, and the third example are further modified via means, processes or techniques for triggering the execution of the sequence of one or more application commands in response to an identified synchronization between the motions of one or more user body parts between two or more different users.

As a seventh example, in various implementations, the sixth example is further modified via means, processes or techniques for identifying the synchronization by comparing time stamps associated with the composite motion recognition windows of the two or more different users.

As an eighth example, in various implementations, any of the sixth example and the seventh example are further modified via means, processes or techniques for identifying the synchronization in response to a determination that the user worn control devices of the two or more users are within a minimum threshold distance of at least one of the user worn control devices of at least one of the other users.

As a ninth example, in various implementations, any of the sixth example and the seventh example are further modified via means, processes or techniques for triggering an automatic exchange of data between computing devices associated with the two or more users in response to the identified synchronization.

As a tenth example, in various implementations, any of the sixth example and the seventh example are further modified via means, processes or techniques for triggering an automatic exchange of user contact information between computing devices associated with the two or more users in response to the identified synchronization.

As an eleventh example, in various implementations, a system is provided via means, processes or techniques for applying a general purpose computing device and a computer program comprising program modules executable by the computing device, wherein the computing device is directed by the program modules of the computer program to extract features from one or more sequential periods of acceleration and angular velocity data received from one or more separate sets of inertial sensors, each separate set of inertial sensors being coupled to a separate one of a plurality of user worn control devices. This system then passes the extracted features to a probabilistic machine-learned motion sequence model. This system then applies the machine-learned motion sequence model to the extracted features to identify a sequence of one or more corresponding motions of one or more user body parts. This system then triggers execution of a sequence of one or more application commands in response to the identified sequence of motions, thereby increasing user interaction performance and efficiency by enabling users to interact with computing devices by performing body part motions.

As a twelfth example, in various implementations, the eleventh example is further modified via means, processes or techniques for implementing at least one of the plurality of user worn control devices as a wrist worn control device, and wherein the identified sequence of motions includes a twist of the user's wrist that triggers execution a communications session of a communications device.

As a thirteenth example, in various implementations, any of the eleventh example and the twelfth example are further modified via means, processes or techniques for identifying synchronization between the motions of one or more user body parts between two or more different users for triggering the execution of the sequence of one or more application commands.

As a fourteenth example, in various implementations, the thirteenth example is further modified via means, processes or techniques for identifying synchronization by determining that the user worn control devices of the two or more different users are within a minimum threshold distance of at least one of the user worn control devices of at least one of the other users, and comparing time stamps associated with the features extracted from the acceleration and angular velocity data associated with the two or more different users.

As a fifteenth example, in various implementations, any of the thirteenth example and the fourteenth example are further modified via means, processes or techniques for triggering an automatic exchange of data between computing devices associated with the two or more different users.

As a sixteenth example, in various implementations, a computer-readable medium having computer executable instructions stored therein for identifying user motions, said instructions causing a computing device to execute a method comprising system, is provided via means, processes or techniques for constructing a composite motion recognition window by concatenating an adjustable number of sequential periods of inertial sensor data received from one or more separate sets of inertial sensors, each separate set of inertial sensors being coupled to a separate one of a plurality of user worn control devices. The composite motion recognition window is then passed to a motion recognition model trained by one or more machine-based deep learning processes. A motion recognition model is then applied to the composite motion recognition window to identify a sequence of one or more predefined motions of one or more user body parts. Execution of a sequence of one or more application commands is then triggered in response to the identified sequence of one or more predefined motions, thereby increasing user interaction performance and efficiency by enabling users to interact with computing devices by performing body part motions.

As a seventeenth example, in various implementations, the sixteenth example is further modified via means, processes or techniques for periodically retraining the motion recognition model in response to sensor data received from the control devices of one or more users.

As an eighteenth example, in various implementations, any of the sixteenth example and the seventeenth example are further modified via means, processes or techniques for identifying synchronization between the motions of one or more user body parts between two or more different users triggers the execution of the sequence of one or more application commands.

As a nineteenth example, in various implementations, the eighteenth example is further modified via means, processes or techniques for identifying the synchronization by comparing time stamps associated with the composite motion recognition windows of the two or more different users when it is determined that the user worn control devices of the two or more users are within a minimum threshold distance of each other.

As a twentieth example, in various implementations, any of the eighteenth example and the nineteenth example are further modified via means, processes or techniques for triggering an automatic exchange of user contact information between computing devices associated with the two or more users in response to the identified synchronization.

The foregoing description of the Natural Motion Controller has been presented for the purposes of illustration and description. It is not intended to be exhaustive or to limit the claimed subject matter to the precise form disclosed. Many modifications and variations are possible in light of the above teaching. Further, it should be noted that any or all of the aforementioned alternate implementations may be used in any combination desired to form additional hybrid implementations of the Natural Motion Controller. It is intended that the scope of the Natural Motion Controller be limited not by this detailed description, but rather by the claims appended hereto. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other equivalent features and acts are intended to be within the scope of the claims.

What has been described above includes example implementations. It is, of course, not possible to describe every conceivable combination of components or methodologies for purposes of describing the claimed subject matter, but one of ordinary skill in the art may recognize that many further combinations and permutations are possible. Accordingly, the claimed subject matter is intended to embrace all such alterations, modifications, and variations that fall within the spirit and scope of detailed description of the Natural Motion Controller described above.

In regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the foregoing implementations include a system as well as a computer-readable storage media having computer-executable instructions for performing the acts and/or events of the various methods of the claimed subject matter.

There are multiple ways of realizing the foregoing implementations (such as an appropriate application programming interface (API), tool kit, driver code, operating system, control, standalone or downloadable software object, or the like), which enable applications and services to use the implementations described herein. The claimed subject matter contemplates this use from the standpoint of an API (or other software object), as well as from the standpoint of a software or hardware object that operates according to the implementations set forth herein. Thus, various implementations described herein may have aspects that are wholly in hardware, or partly in hardware and partly in software, or wholly in software.

The aforementioned systems have been described with respect to interaction between several components. It will be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (e.g., hierarchical components).

Additionally, it is noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

What is claimed is:

1. A computer-implemented process, comprising:
constructing a composite motion recognition window by concatenating an adjustable number of sequential periods of inertial sensor data received from one or more separate sets of inertial sensors, each separate set of inertial sensors being coupled to a separate one of a plurality of user worn control devices;
passing the composite motion recognition window to a motion recognition model trained by one or more machine-based deep learning processes;
applying the motion recognition model to the composite motion recognition window to identify a sequence of one or more predefined motions of one or more user body parts; and
triggering execution of a sequence of one or more application commands in response to the identified sequence of one or more predefined motions, thereby increasing user interaction performance and efficiency by enabling users to interact with computing devices by performing body part motions.

2. The computer-implemented process of claim 1 further comprising periodically retraining the motion recognition model in response to sensor data received from the control devices of one or more users.

3. The computer-implemented process of claim 2 wherein retraining the motion recognition model is performed a per-user basis on a local copy of the motion recognition model associated with the user worn control devices of individual users.

4. The computer-implemented process of claim 1 wherein at least one of the plurality of user worn control devices is a wrist worn control device, and wherein the sequence of one or more predefined motions includes a twist of the user's wrist.

5. The computer-implemented process of claim 4 wherein the twist of the user's wrist triggers execution a communications session of a communications device.

6. The computer-implemented process of claim 1 wherein an identification of synchronization between the motions of one or more user body parts between two or more different users triggers the execution of the sequence of one or more application commands.

7. The computer-implemented process of claim 6 wherein the synchronization is identified by comparing time stamps associated with the composite motion recognition windows of the two or more different users.

8. The computer-implemented process of claim 6 wherein the synchronization is identified following a determination that the user worn control devices of the two or more users are within a minimum threshold distance of at least one of the user worn control devices of at least one of the other users.

9. The computer-implemented process of claim 6 wherein the triggered execution of the sequence of one or more application commands causes an automatic exchange of data between computing devices associated with the two or more users.

10. The computer-implemented process of claim 6 wherein the triggered execution of the sequence of one or more application commands causes an automatic exchange of user contact information between computing devices associated with the two or more users.

11. A system, comprising:
a general purpose computing device; and
a computer program comprising program modules executable by the computing device, wherein the computing device is directed by the program modules of the computer program to:
extract features from one or more sequential periods of acceleration and angular velocity data received from one or more separate sets of inertial sensors, each separate set of inertial sensors being coupled to a separate one of a plurality of user worn control devices;
pass the extracted features to a probabilistic machine-learned motion sequence model;
apply the machine-learned motion sequence model to the extracted features to identify a sequence of one or more corresponding motions of one or more user body parts; and
trigger execution of a sequence of one or more application commands in response to the identified sequence of motions, thereby increasing user interaction performance and efficiency by enabling users to interact with computing devices by performing body part motions.

12. The system of claim 11 further wherein at least one of the plurality of user worn control devices is a wrist worn control device, and wherein the identified sequence of motions includes a twist of the user's wrist that triggers execution a communications session of a communications device.

13. The system of claim 11 wherein an identification of synchronization between the motions of one or more user body parts between two or more different users triggers the execution of the sequence of one or more application commands.

14. The system of claim 13 wherein the synchronization is identified by:
determining that the user worn control devices of the two or more different users are within a minimum threshold distance of at least one of the user worn control devices of at least one of the other users; and
comparing time stamps associated with the features extracted from the acceleration and angular velocity data associated with the two or more different users.

15. The system of claim 13 wherein the triggered execution of the sequence of one or more application commands causes an automatic exchange of data between computing devices associated with the two or more different users.

16. A computer-readable medium having computer executable instructions stored therein for identifying user motions, said instructions causing a computing device to execute a method comprising:
constructing a composite motion recognition window by concatenating an adjustable number of sequential periods of inertial sensor data received from one or more separate sets of inertial sensors, each separate set of inertial sensors being coupled to a separate one of a plurality of user worn control devices;
passing the composite motion recognition window to a motion recognition model trained by one or more machine-based deep learning processes;
applying the motion recognition model to the composite motion recognition window to identify a sequence of one or more predefined motions of one or more user body parts; and
triggering execution of a sequence of one or more application commands in response to the identified sequence of one or more predefined motions, thereby increasing user interaction performance and efficiency by enabling users to interact with computing devices by performing body part motions.

17. The computer-readable medium of claim 16 further comprising computer executable instructions for periodically retraining the motion recognition model in response to sensor data received from the control devices of one or more users.

18. The computer-readable medium of claim 16 wherein an identification of synchronization between the motions of one or more user body parts between two or more different users triggers the execution of the sequence of one or more application commands.

19. The computer-readable medium of claim 18 wherein the synchronization is identified by comparing time stamps associated with the composite motion recognition windows of the two or more different users when it is determined that the user worn control devices of the two or more users are within a minimum threshold distance of each other.

20. The computer-readable medium of claim 18 wherein the triggered execution of the sequence of one or more application commands causes an automatic exchange of user contact information between computing devices associated with the two or more users.
